(19) United States
(12) Patent Application Publication
(10) Pub. No.: US 2015/0066950 A1
(43) Pub. Date: Mar. 5, 2015

(54) SENTIMENT SCORING FOR SPORTS ENTITIES AND FILTERING TECHNIQUES

(71) Applicant: Sporting Vote, Inc., San Francisco, CA (US)

(72) Inventors: Roman Tobe, San Francisco, CA (US); Dean Tobe, San Francisco, CA (US)

(73) Assignee: Sporting Vote, Inc., San Francisco, CA (US)

(21) Appl. No.: 14/165,086

(22) Filed: Jan. 27, 2014

Related U.S. Application Data
(60) Provisional application No. 61/874,198, filed on Sep. 5, 2013.

(51) Int. Cl. G06F 17/30

(52) U.S. Cl. CPC G06F 17/30312
USPC 707/748

(57) ABSTRACT

In an embodiment, a data processing method comprises displaying, in a social network system, an entity and an entity sentiment value for the entity where the entity sentiment value corresponds to user sentiments in regards to the entity and where a higher value indicates a more positive sentiment; displaying other entities where all the entities are related to a team entity; receiving a particular sentiment value that is for the entity; in response to receiving the particular sentiment value, recalculating the entity sentiment value and calculating the team entity sentiment value; redisplaying the entity sentiment value. In another embodiment, a data processing method comprises displaying, in a social network system, user comments related to an entity; receiving a selected range of sentiment values related to the entity; in response to receiving the selected range of sentiment values, causing displaying only user comments that have an associated user sentiment value within the selected range.

### BENEFIT CLAIM

This application claims the benefit under 35 U.S.C. §119(e) of provisional application 61/874,198, filed Sep. 5, 2013, the entire contents of which is hereby incorporated by reference for all purposes as if fully set forth herein.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE DISCLOSURE

The present disclosure relates to social networking, particularly techniques for quantifying sentiments regarding various entities.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Social network systems may be employed to facilitate sharing of information among users. Users subscribe to a social network system to share information with their peers and to access information shared by their peers. A social network system enables such interaction by allowing users to contribute information in many different forms such as textual comments, photos, news article and etc. The system then processes the received data from users and represents this data back to other users. Since user contributions are vital to the success of a social network system, the system may utilize effective methods to collect and present the information from users in a manner to encourage future contributions from users.

As the number of users increases, a social network system may handle an increasing amount of information. In order to avoid flooding users with excessive data, methodologies may be developed for a social network system to meaningfully represent the vast amount of user contributed information while accommodating multitude of user interests. One such methodology is to limit the number of users that a user can share and receive information from. The FACEBOOK service uses the “friend” concept, and GOOGLE+ uses a similar concept of “circles.” In such systems, users may share information with other users who are “friends” or are in the “circle” with the user, and the user can generally access only information shared by users who are “friends” or who are within “circles.” Thus, such systems assume that a user is only interested in the information shared by the associated users, and that such information is usually relevant for the user.

However, in such systems, if a user wishes to learn a community perception about an entity such as an athlete or a politician, then the user may be limited to receiving only the opinions of associated users. Additionally, such systems generally employ a free form sharing methodology, where a user can share information in any form such as a comment, a link to a news story, a photo or even a video. This freedom leads to further complexity for the user to ascertain the community perception regarding the entity. Still other systems permit commenting or contributions of content by any registered user regardless of any link as a friend, through a circle, or other association with other users. In these systems, each user typically receives all comments of all users relating to a particular topic; in some cases involving subscription services, comments of non-subscribers might be filtered out. However, in all these cases, the user may have to parse through almost random contributions of the associated users to ascertain the perception on the entity of choice. For example, in sports-oriented systems, a user who is a fan of a hypothetical Team Alpha typically is required to read comments posted by both other fans and people who hate Team Alpha or favor a rival; in some cases, the emotional level of the comments is quite high and the fan of Team Alpha would prefer not to see comments from “haters”. Using manual means to skim over undesired comments would be extremely tedious for the user and would leave the user without any effective way to quantify such perception.

### SUMMARY

The appended claims may serve as a summary of the invention.

### BRIEF DESCRIPTION OF THE DRAWINGS

In the drawings:

FIG. 1A illustrates a computer system that may be used to implement an embodiment.

FIG. 1B illustrates an example process of quantifying user sentiment.

FIG. 2 illustrates an example graphical user interface to view and edit sentiment values for sports entities.

FIG. 3 illustrates an example graphical user interface to view additional information and edit sentiment values of a sports entity.

FIG. 4 illustrates an example graphical user interface to view statistics related to a sports entity.

FIG. 5 illustrates an example graphical user interface to view polls related to sports entities.

FIG. 6 illustrates an example graphical user interface to view previously voted polls related to sports entities.

FIG. 7 illustrates a process of filtering comments based on user sentiment.

FIG. 8 illustrates an example graphical user interface to view user comments related to a sports entity.

FIG. 9 illustrates an example graphical user interface for a selection of a sentiment value range to filter user comments related to a sports entity.

FIG. 10 illustrates an example graphical user interface for displaying comments in response to a selection of a new minimum sentiment value.

FIG. 11 illustrates a computer system upon which an embodiment may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. Overview

In an embodiment, a social network system comprises computer logic that is configured to quantify sentiments for an entity by receiving, analyzing and presenting sentiment data related to the entity. An entity may be any person or organization such as a celebrity, politician, athlete, sports team, political party or industry group. The entities may be hierarchically related to each other such that an entity may be a member of another entity. For example, an athlete may be a member of a sports team, and a politician may be a member of a political party.

In an embodiment, a social network system is configured to present sentiment data related to an entity by displaying sentiment values for the entity. A sentiment value is a value from a sentiment value range, where the sentiment value range represents a full spectrum of quantified perceptions by a user or community of users regarding an entity. Sentiment values may be numeric values. In an embodiment, a social network system quantifies perception by assigning a minimum value to the most negative perception and assigning a maximum value to the most positive perception. Thus, the sentiment value range may be a numerical value range where smallest number represents the most negative perception and the greatest number corresponds to the most positive perception. However, embodiments are not limited to any particular sentiment value range representation. Other embodiments are conceived for representing a sentiment value range, such as any set of values that have a perceived order amongst the values, where the order represents increasing or decreasing, positive or negative perception.

In an embodiment, upon a selection of a particular sentiment value for an entity from a sentiment value range, a social network system receives this value and stores the value as a user sentiment value in a non-transitory memory such as database or file system. In response to receiving the user sentiment value, the social network system may calculate other sentiment data using aggregate functions. An aggregate function may be any function that performs computation on a set of sentiment values including the newly received value. The aggregate function then produces an aggregate sentiment value that represents a certain characteristic of the set. In an embodiment, a mean aggregate function may be performed on all received user sentiment values for an entity to determine a community sentiment value for the entity. Furthermore, if an entity is related to other entities, an aggregate sentiment value for the entity may be based on performing aggregate functions on sentiment values for the related entities as well. For example, in an embodiment, a community sentiment value for a team entity is an average of all community sentiment values for team member entities of the team entity. In a related embodiment, a community sentiment value for a team entity is an average of a user sentiment value for the team entity and all community sentiment values for team member entities.

In an embodiment, a social network system displays entity information with entity sentiment data that comprises a received user sentiment value and a calculated aggregate sentiment values for the entity. The entity sentiment data may further comprise temporal information regarding the sentiment values. In an embodiment, such temporal information may be a change in the community sentiment value for the entity for a specified time period. For example, temporal information may comprise a daily percentage change of the community sentiment value for the entity.

In an embodiment, in response to a selection of polling information related to an entity, a social network system displays polling statements associated with the entity. A polling statement may be any statement that would procure opinions from users and may be formatted as text, picture, video or any combination thereof. A polling statement may comprise an assertion regarding the entity or related entities. In an embodiment, polling statements may be ordered by popularity such that the polling statements that have received the most votes are displayed at the top. In an embodiment, a social network system further displays a set of links associated with each statement to enable voting on the statement by selecting a link out of the set. In response to receiving a particular vote, the social network system calculates a vote tally for the statement, stores the calculated vote tally with the received vote in a non-transitory memory, and displays the vote and the vote tally with the statement.

In an embodiment, in response to a selection of comment information related to an entity, a social network system displays user comments associated with the entity. The social network system further displays an input field for entry of new comments. In response to entry of a new comment, the social network system receives the comment, stores it in a non-transitory memory and displays it along with the other comments. Upon request, the social network system may also send the received comment to other social network systems for publishing where such comments may contain special tags recognized by the other social network system. The social network system may arrange the comments in an order based on total number of comment contributions by a user of a comment.

In an embodiment, a social network system is configured to filter comments related to an entity based on a user sentiment value in response to a filtering request. In an embodiment, the social network system displays, in association with a comment, a user sentiment value that has been received from the user of the comment for the entity to which the comment relates. To filter the comments, the social network system displays a selectable range of sentiment values. In response to receiving a selection of a range of sentiment values, the social network system displays only the comments that have a user sentiment value that is within the selected range. Thus, the social network system filters comments to display only comments from users that have a sentiment value for an entity within the selected range.

In an embodiment, a sentiment value is within a selected range if the sentiment value is less than or equal to a maximum value in the selected range and is greater than or equal to a minimum value in the selected range. In another embodiment, where a selected range has no defined maximum value, a sentiment value is within the selected range if the sentiment value is greater than or equal to a minimum value in the selected range. In another embodiment, where a selected range has no defined minimum value, a sentiment value is within the selected range if the sentiment value is less than or equal to a maximum value in the selected range.

For purposes of illustrating a clear example, the description herein sometimes refers to particular numerical values and particular numeric ranges such as 1-100. These values and ranges represent examples, and other embodiments may use other values and ranges; in particular, the use of the range 1-100 is not required.

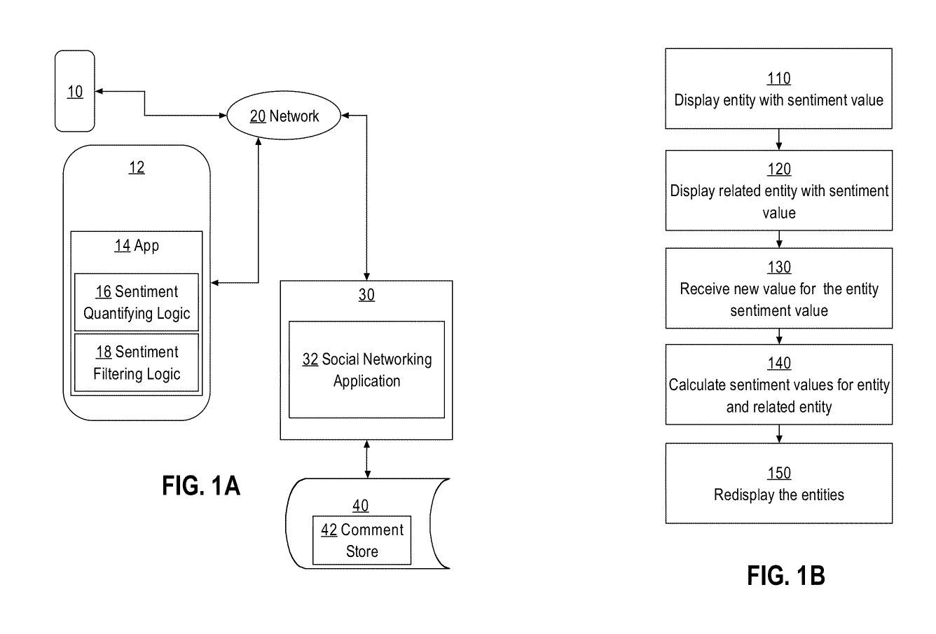

FIG. 1A illustrates a computer system that may be used to implement an embodiment. In one implementation, a plurality of mobile computing devices 10, 12 are coupled to a network to which an application computer 30 also is coupled. Mobile computing devices 10, 12 broadly represent any form of computing device having a processor, display, memory and networking capability, including but not limited to smartphones, tablet computers, netbook computers, and laptop or ultrabook computers. For purposes of illustrating a clear example, FIG. 1A shows a limited number of devices 10, 12 but other embodiments may use any number of devices and the inventors specifically contemplate use of embodiments with thousands or millions of devices.

Network 20 broadly represents one or more access points, local area networks, wide area networks, internetworks or a combination thereof including infrastructure such as routers and switches. In an embodiment, network 20 may include the public internet. Application computer 30 broadly represents one or more computers, data centers, virtual machine instances, or cloud-based resource combinations including processors, storage and memory.

In an embodiment, mobile computing device 12 or any other such device has installed, hosts and executes an application or app 14 that is configured with sentiment quantifying logic 16 and sentiment filtering logic 18. The logic 16, 18 may operate independently to perform certain functions described herein locally to mobile computing device 12 such as receiving user input, forming user interface displays or UI widgets, updating local memory with sentiment values, filtering the display of comments based on sentiment values, and others as described herein. The logic 16, 18 also may send and receive messages using any of a plurality of networking protocols such as TCP/IP, HTTP, and others to communicate with a social networking application 32 that is hosted at the application computer 30.

The social networking application 32 implements a service in which a large number of users may register, create accounts, log in, view data relating to topics of interest, and create and store comments that are collected in a data storage device 40 such as in a comment store 42. The social networking application 32 and comment store 42 collectively may implement a comment service, forum, or other service that associates a large number of comments of different users with specified entities, as further described. Logic 16, 18 and social networking application 32 may cooperate to create and store sentiment score values in association with users, entities, and/or comments as further described herein. Logic 16, 18 and social networking application 32 may cooperate to filter comments in comment store 42 for display using app 14 based upon the sentiment score values in association with users, entities, and/or comments as further described herein.

1. Sentiment Scoring for Sports Entities

In an embodiment, users of a social networking system are provided with user interface elements permitting the user to express evaluations of sports entities. Embodiments provided herein permit users to register their evaluations of sports entities using numerical sentiment values, for example, ranging from 1-100, where 1 is the lowest, most unfavorable value and 100 is the highest, most favorable value. The sentiment values may be established by users of the system. The social networking system displays sentiment values expressed by users of the system. These values are displayed on the individual user level, as well as the aggregate average of all users who have expressed numerical sentiment values of a given sports entity.

Numerical sentiment values allow for thoughts and ideas to be shared by users of the social networking system in a quantitative format. Topics, as it pertains to the embodiments, are about sports entities, athletes, front office personnel, and the teams themselves. The quantitative format serves as an alternative to written thoughts and ideas that express evaluations of sports entities. The numerical format allows for users of the social networking system to understand the sentiment of a sports athlete, and views of other users, in an easy to understand measurement of expressions of evaluations. These user-established values are stored in the social networking system, and are visible when a user visits the social networking system. The user values are displayed within the social networking system within the registrar's sentiment value history, and as a contribution to the aggregate average of the sports entities numerical sentiment value score.

As an example, the following process may be implemented:

1. Sports Athlete A has no numerical sentiment value range of 1-100.

2. User A is the first to register Sports Athlete A on a numerical sentiment value range of 1-100 as a 25. This is considered fairly low.

3. User B registers Sports Athlete A on a numerical sentiment value range of 1-100 as a 75. This is considered fairly high.

4. Sports Athlete A now has an aggregate average sentiment value (SV) of 50.

5. User C views Sports Athlete A on the social networking system.

6. User C can quickly determine sentiments of User A and User B in relation to Sports Athlete A.

7. User C registers Sports Athlete A on a numerical sentiment value range of 1-100 as a 70. This is considered fairly high.

8. User C has contributed their sentiment to Sports Athlete A, and identified like-minded fan in User B.

9. User C begins an online conversation with User B about Sports Athlete A on social networking site.

Thus, embodiments may provide a process of locating other users of a social networking site based upon similarity of the sentiment scores. Further, embodiments may provide a process of determining an aggregate quantitative sentiment score for a particular sports-related entity {player, coach/manager, management organization, team} based upon individual sentiment scores received from a population of users of a social networking system.

In one embodiment, a method for contributing content on a page within a social networking system is provided, comprising a mechanism for registering a numerical sentiment value range for sports entities using a 1-100 numerical value range. The user will engage with this mechanism via a user interface element that lets the user select an individual numerical value from 1-100. The system is configured for receiving a numerical sentiment value range from a user of the social networking system by registering the value to a sports entity and determining that an expression includes the numerical value, and displaying the numerical value to other users of the social networking system. The method may further comprise displaying a numerical value to other users by displaying it within a sentiment value history, and as a contribution to the aggregate average of the sports entities numerical sentiment value score.

In one particular embodiment, a social network system quantifies user sentiments related to entities by displaying information about an entity and providing means for selection of a sentiment value within a sentiment value range. When a sentiment value is received for an entity, other sentiment values, aggregate sentiment values, are calculated based on performing an aggregate function on received values. In various embodiments, such aggregate sentiment values may be an average, a minimum or a maximum of user sentiment values; a user sentiment value change for a time period; a community sentiment value; a community maximum or minimum sentiment value; or a community sentiment value change for a time period. In other embodiments, similar values are calculated for an entity related to the entity, such as a team entity, for which the user sentiment value has been received.

FIG. 1B illustrates an example process of quantifying user sentiment. At block 110, the process displays entity information with a sentiment value. At block 120, the process displays information about a related entity, such as a team entity, with a sentiment value for the related entity. At block 130, a new sentiment value is received. In response to block 130, at block 140, updated sentiment values are calculated for the entity and the related entity. At block 150, the updated sentiment values with the entity information are redisplayed.

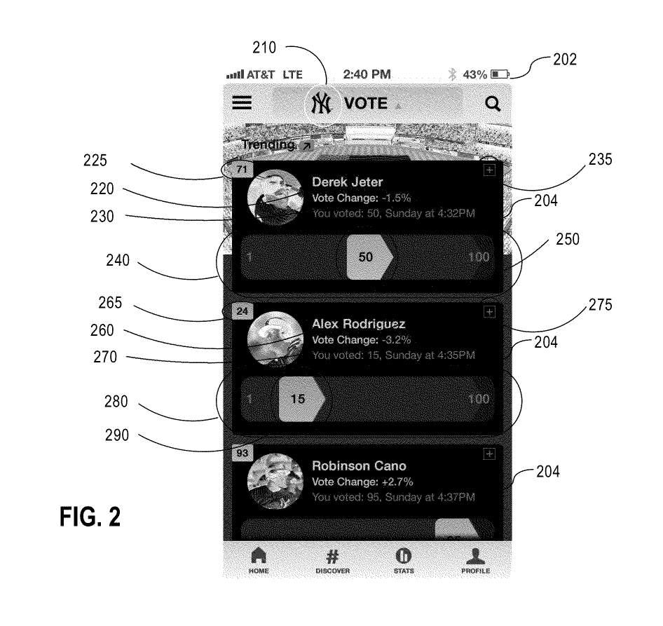

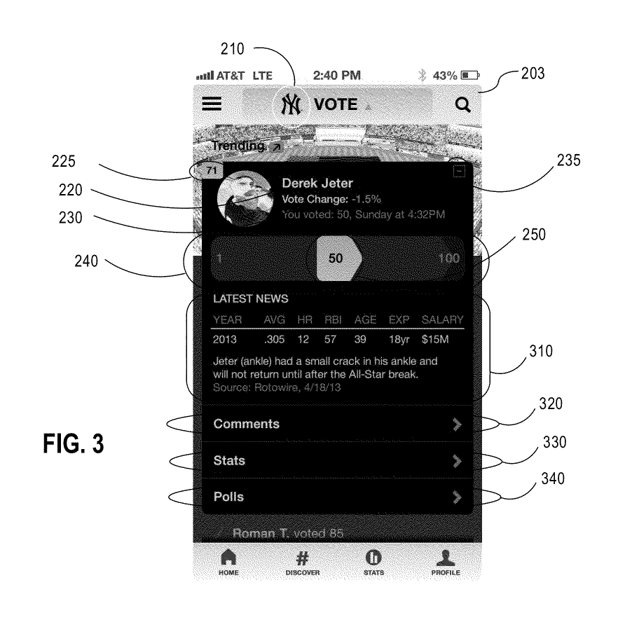

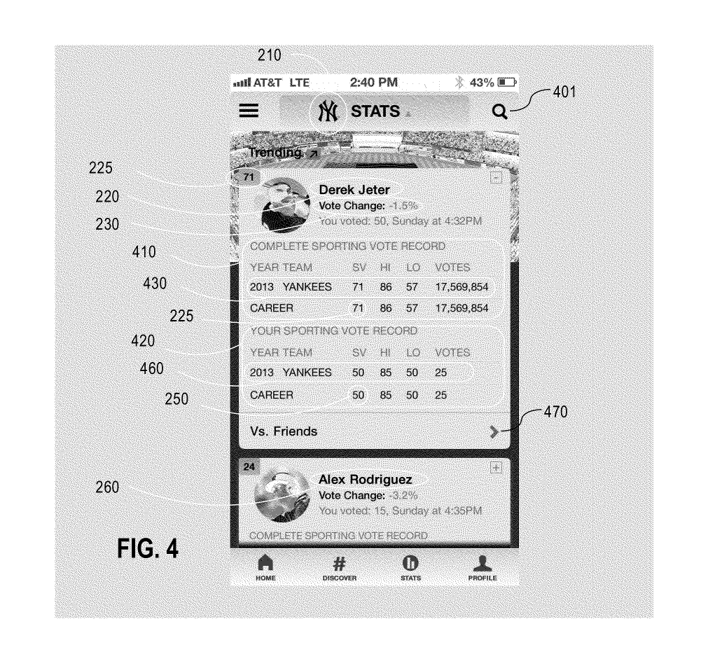

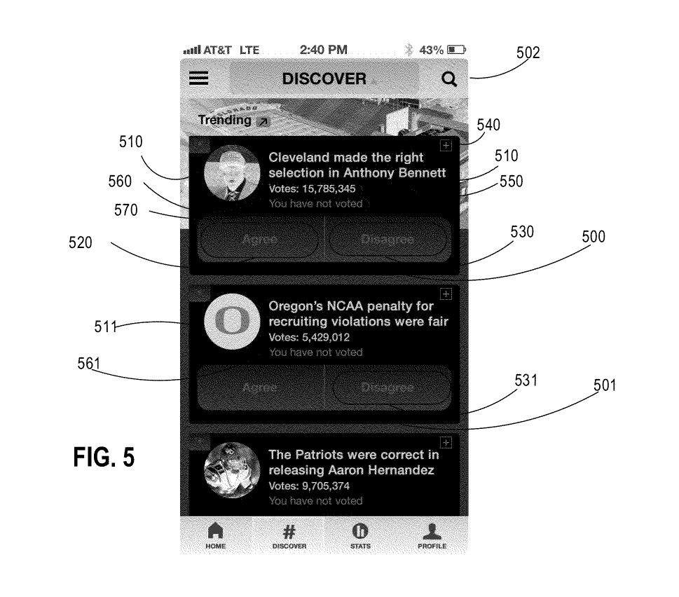

FIG. 2, FIG. 3, FIG. 4, FIG. 5 illustrate example graphical user interfaces that are configured for use in processes of quantifying user sentiments related to sports entities in various embodiments. Referring first to FIG. 2, an example graphical user interface to view and edit sentiment values for sports entities is shown for one embodiment. In an embodiment, a graphical user interface 202 comprises a plurality of player panels 204 in which each panel is associated with a specified athlete. In the example of FIG. 2, three (3) panels 204 are displayed for sports entities in the form of the athletes as indicated by labels 220, 260 for Derek Jeter and Alex Rodriguez. Panels 204 may be displayed with an identifier 210 of a related sports team entity such as NEW YORK YANKEES.

In an embodiment, the logic 16, 18 may cooperate further with application 32 to display each athlete's community sentiment value and user sentiment value. In the example of FIG. 2, first and second panels 204 for Derek Jeter and Alex Rodriguez comprise respective community sentiment values 225, 265 of “71” and “24”. In the same example, change labels 230, 270 indicate changes over time in the community sentiment values for the athletes.

In an embodiment, each panel 204 further comprises a slider widget 240 having an indicator 250 that graphically represents a then-currently selected user sentiment value for the entity associated with the panel. Thus, in the example of FIG. 2, the user of the app has selected or is currently selecting a user-specific sentiment value of “50” for Derek Jeter. Each slider widget 240 represents a user-specific sentiment value for an entity associated with a panel 204 in which the widget appears in a range, for example, from 1 to 100, where 1 is the most negative perception and 100 is the most positive perception. In an embodiment, in response to user touch input indicating sliding the indicator 250 within the slider widget 240, the user sentiment value for the associated entity is changed proportionally in response to a lateral position of the indicator within the slider widget. In this manner, the user sentiment value for a particular entity of a panel 204 may be modified to match a user's real-life perception of the entity.

In an embodiment, in response to receiving a new user sentiment value for an entity of the first panel 204 featuring Derek Jeter, the community sentiment value 225 for that panel is recalculated and re-displayed to estimate the new aggregate perception of the community of all users of the social network system.

The user sentiment value may be changed similarly for the second panel 204 representing Alex Rodriguez as seen at label 260 by sliding the indicator 290 within a slider widget 280 for that panel. In response, the community sentiment value 265 is recalculated and re-displayed.

Each of the panels 204 comprises a toggle widget 235, 275 which, when selected, causes displaying additional information relating to the entity that is the subject of the panel. FIG. 3 illustrates an example of a graphical user interface to view additional information and edit sentiment values of a sports entity, in a related embodiment. In the example of FIG. 3, a screen display 203 comprising detailed entity data may be accessed from screen display 202 of FIG. 2 by selecting toggle widget 235 in FIG. 2. Conversely, selecting the toggle widget 235 from within screen display 203 of FIG. 3 causes redisplaying the view of FIG. 2.

In the example of FIG. 3, screen display 203 comprises the elements of FIG. 2 that have been previously described. Further, in an embodiment, screen display 203 of FIG. 3 includes additional information related to the subject of the selected entity, such as Derek Jeter as indicated by label 220. In one embodiment, news information 310 such as statistics and alert messages may be displayed. Screen display 203 also may comprise one or more hyperlinks 320, 330, 340 that are configured for obtaining other information about the entity in response to selection of the hyperlinks. As an example, the hyperlinks may be configured to provide comments through comment link 320, additional statistics through stats link 330 and polls through poll link 340.

FIG. 4 illustrates an example of a graphical user interface to view statistics related to a sports entity, in an embodiment. In one implementation, FIG. 4 comprises a screen display 401 that may be accessed from the screen display 203 of FIG. 3 by selecting stats link 330; in response, the view of FIG. 4 is generated and displayed on the mobile computing device. In one implementation, FIG. 4 comprises certain elements as illustrated in FIG. 2 and FIG. 3, as indicated by like reference numerals.

Further, in an embodiment screen display 401 of FIG. 4 comprises a community statistics panel 410 and a user statistics panel 420. In an embodiment, the community statistics panel 410 indicates the community sentiment value 225 for the associated entity, and one or more aggregate sentiment values for the same entity based on user sentiment values received from all users of the social networking system and relating to one or more different events or time periods. For example, a community statistics panel 410 may comprise a first row 430 associated with a first particular year, and a second row associated with a career that consists of a plurality of years. Each row 430 in an embodiment comprises an identifier, a current sentiment value, a high sentiment value, a low sentiment value, and a vote count value; the values are aggregates for all users of the social networking system. For example, row 430 comprises a current sentiment value of “71”, a high sentiment value of “86”, a low sentiment value of “57”, and a particular vote count value. The low and high sentiment values may indicate low and high values actually recorded in the social networking system either since inception or only for the particular year or event that is associated with a row. In the example of FIG. 4, row 430 indicates values for the entity Derek Jeter during the year 2013 in which Jeter was a member of the New York Yankees.

Similarly, in an embodiment the user statistics panel 420 comprises a plurality of rows 460 that illustrate statistics for the same entity based on user sentiment values received from a particular user. The same metrics may differentiate row 460 from other rows in the statistics panel 420 as for panel 410; that is, different rows may be based upon years, events or other metrics. In an embodiment, each row 460 comprises a current sentiment value, a high sentiment value, a low sentiment value, and a vote count value; the values are individual for the particular user of the social networking system. For example, FIG. 4 indicates that the current user has entered 25 votes over time and those votes included a highest sentiment value of “85”, a lowest sentiment value of “50”, and a current sentiment value of “50” for year 2013 as indicated in row 460.

In an embodiment, screen display 401 further comprises a comparison control 470 which when selected causes displaying a new screen display that compares the current user's data as shown in panel 420 to data values for the same entity as shown in label 220 for other users with which the current user is associated. In this manner, the current user may compare their sentiment values with other known users rather than a larger, more anonymous community.

In response to user input indicating scrolling the screen display 401, in one embodiment, the screen display is updated to show statistical data in a similar form for other entities such as Alex Rodriguez as indicated in label 260 of FIG. 4.

FIG. 5 illustrates an example of a graphical user interface to view polls related to sports entities, in an embodiment. In an embodiment, FIG. 5 comprises a screen display 502 that may be accessed from the view of FIG. 3 by selecting poll link 340. In an embodiment, screen display 502 comprises one or more poll panels 500, 501. In an embodiment, each poll in screen display 502 is related to a different entity; for example, poll panel 500 is related to Anthony Bennett as seen in label 510 and poll panel 501 is related to OREGON DUCKS as seen in label 511. In an embodiment, polls for panels 500, 501 are ordered based on a number of users that have voted in a poll, as indicated for example in polling tally values 560, 561, which represent the number of users that have voted in polls for panels 500, 501, respectively.

In an embodiment, poll panel 500 contains a polling statement 550, polling tally 560, polling status 570, a first polling button 520 and second polling button 530.

Polling statement 550 may comprise an assertion about an entity, in this case Anthony Bennett as in label 510, which prompts a user to agree or disagree with the assertion.

Polling button 520 enables a user to vote to agree with the assertion, and polling button 530 enables a user to vote to disagree with the assertion on poll 500. Selecting a particular one of the polling buttons 520, 530 causes the user computing device to communicate a corresponding vote to the server computer for storage and aggregation. Although the example of FIG. 5 indicates polls that have binary voting options, in other embodiments, three or more voting options may be provided.

In an embodiment, polling status 570 comprises a value based upon a stored Boolean flag indicating whether the current user has entered a vote for the associated poll. In one embodiment, the polling status 570 is displayed only when the current user has not voted in the associated poll. In some embodiments, when a vote has been received, no polling status is displayed.

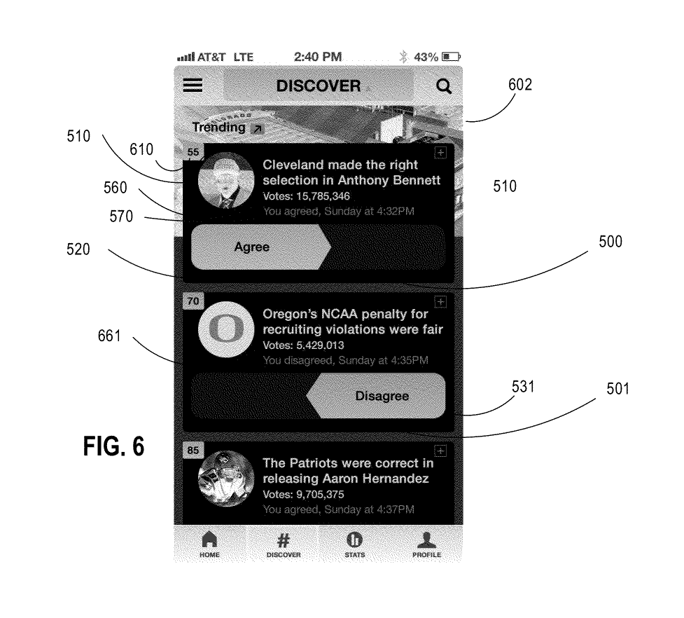

FIG. 6 illustrates an example of a graphical user interface to view previously voted polls related to entities, in an embodiment. In one implementation, a user interface 602 as seen in FIG. 6 is displayed after accessing the screen display 502 of FIG. 5 and selecting polling button 520 of poll panel 500 and polling button 531 of poll panel 501, respectively. In response to selecting these particular buttons, in an embodiment, polling status 570 is updated with information indicating the type of vote such as agreement or disagreement, and a date and/or timestamp at which a vote was entered. Further, the polling tally 560 is incremented and the incremented value appears in screen display 602 when it is redisplayed. The selection of poll button 530 may further cause displaying a community sentiment value 610 for the entity 510 to which the poll panel 500 relates.

Using these approaches, embodiments are configured to provide for defining, storing, tracking, aggregating and reporting sentiment values of a large community of users in a social networking system relating to a plurality of entities. In a mobile computing device, the user interface may be configured to display then-current per-user, individual sentiment values for a particular entity, as well as community-based aggregated sentiment values for the same entity. In this manner, a user can obtain a view of a community's sentiment in relation to a particular entity for comparison to the user's own sentiment for that entity. New techniques are also provided to arrange computer displays and deliver information indicating changes over time in the sentiment values for both a particular user and a community, and to show and associate sentiment values and changes in them with particular years or events associated with an entity.

3. Comment Filtering Based on Sentiment

In an embodiment, users of a social networking system are provided with user interface elements permitting the user to view comments of all users of the social networking systems, while selectively activating functions that are configured to permit users to filter comments within the social networking system based upon sentiment values, so that only comments of other users having personal sentiment values that are equal to or greater than the current user's own sentiment value are displayed. Since user-specific sentiment values are established by users of the system, if left unfiltered, all comments would be displayed in the social networking system including those of users whose sentiment for a particular entity is much different than the sentiment of a current user who is viewing the comments. The use of comment filters based upon sentiment values s described herein provides a user with the ability to modify the social networking experience by not displaying comments by users with lower or higher sentiment values for particular entities. Thus, the system enables the social networking user to view comments from like-minded users, and block those users who do not share similar sentiment values; “haters” can be excluded and like-minded fans can be included, in one approach.

In an embodiment, the disclosure relates generally to filtering content within a social networking system and particularly by filtering comments in online forums using sentiment values determined by users within the social networking system. This filter is used in the social networking system online forum. An online forum may be characterized as a page with one or more topics wherein users may view content and provide comments. For example, online forums allow for thoughts and ideas to be shared via written comments by users of the social networking system. Topics, as it pertains to the embodiments, are about sports entities, athletes, front office personnel, and the teams themselves. In some instances, users may have to be exposed to profane comments about sports entities they favor, and these sports fans have no way of removing the profane comments from the social networking system. Manually deleting comments is not an effective solution to filtering out this online content.

Embodiments are configured to enable a social networking system to filter comments made by users in a social networking system online forum. The filter serves as a self-moderating user interface element that does not delete or remove the profane or unwanted comments from appearing in the user's social networking system online forum experience. However, it does filter, or remove from their unique view the profane or unwanted comments from appearing by using sentiment ranges of other users as the barometer of filtration.

Sentiment ranges, otherwise considered as evaluations of entities such as teams or athletes may be measured on a 1-100 range, where 1 is the lowest, most unfavorable score and 100 is the highest, most favorable score. Users of the social networking system may be provided with user interface elements to record their sentiment ranges of sports athletes as previously described. These user established ranges are then stored in the social networking system, and visible when a user visits the online forum of the social networking system and wants to view comments on a specific online forum topic from like-minded fans.

For example:

1. User A rates Sports Athlete A on a sentiment value range of 1-100 as a 25. This is considered fairly low.

2. User A navigates to online forum about Sports Athlete A and posts an unfavorable comment.

3. User B rates Sports Athlete A on a sentiment value range of 1-100 as a 75. This is considered fairly high.

4. User B navigates to online forum about Sports Athlete A and posts a favorable comment.

5. User C rates Sports Athlete A on a sentiment value range of 1-100 as a 70. This is considered fairly high.

6. User C navigates to online forum about Sports Athlete A and views the comments.

7. User C sees User A's comment about Sports Athlete A and deems this comment as inappropriate and does not want to read unfavorable comments going forward about Sports Athlete A.

8. User C sets the sentiment filter for Sports Athlete A at 50 or higher. Comments from users with a sentiment value of 50 or higher will only appear for User C while on Sports Athlete A online forum.

9. User C no longer sees User A's unfavorable comment about Sports Athlete A.

10. User C sees User B favorable comment about Sports Athlete A, and has an online conversation with User B in the online forum. User B is a like-minded fan.

Various embodiments may implement one or more of the following general concepts using computer programs, digital computing logic, or other computing elements in the configurations described herein:

A method for moderating content on a page within a social networking system, comprising: A mechanism for filtering the visibility of peer-to-peer comments on a social networking system by selecting a numerical sentiment value ranges from 1-100 by comment authors. The user will engage with this filter via a user interface element that allows the user to select greater than or less than a particular value selected from the range of 1-100. Once the user has selected a numerical sentiment of greater than or less than 1-100, the user has blocked visibility of other users' comments within the social networking system below that value.

The user will be able to view comments on the social networking system that are at or above the preferred numerical sentiment value. The user will only be able to access this user interface element on the social networking system. The user can re-calibrate their numerical value sentiment filter range by re-setting the filter to a different numerical value. There is no limit on the number of re-calibrations the user can provide to the user interface element to adjust their numerical sentiment value preference.

In an embodiment, a social network system may filter user comments based on quantified sentiments. In addition to enabling a user to contribute a user sentiment value to an entity, a social network system may further enable the user to contribute comments that are related to the entity. In various embodiments, comments may be in different formats such as textual or digital and may contain text, a link, a photo or a video or any combination thereof. However, the embodiments are not limited to any particular format or content for comments. When a comment related to an entity is received and stored, the social network system associates a user sentiment value for the entity to the received comment. Such association enables a social network system to filter comments based on user sentiment values.

In an embodiment, a social network system displays comments along with associated user sentiment values. Upon the receipt of a selected set of user sentiment values, a social network system displays only comments that have associated user sentiment values within the selected set. Thus, the social network system filters comments based on the selected user sentiment values.

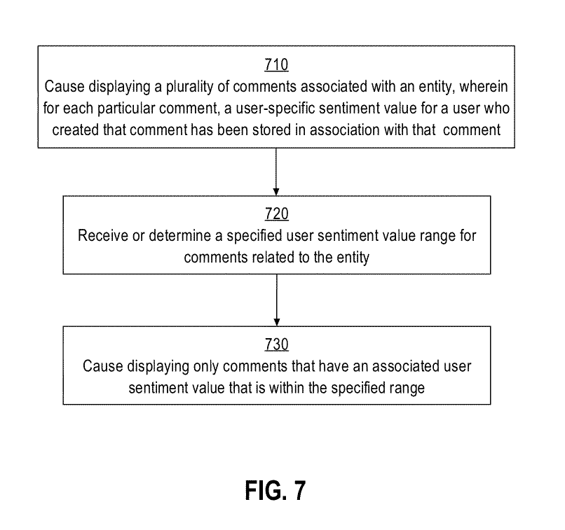

FIG. 7 is a flow diagram that illustrates a process of filtering comments based on user sentiment, in an embodiment. A social network system causes displaying in a computer display device a plurality of comments associated with an entity at block 710. In various embodiments, the entity may be a team, athlete, celebrity, or other subject. A user-specific sentiment value for a user who created each particular comment for the entity is stored in association with the comment, as further seen in block 710. For example, comment store 42 of storage device 40 may store a large number of comments of different users, in which each comment is associated with a particular entity, and each comment may have an associated stored user-specific sentiment value. For example, a comment forum, news feed, conversation panel, or other element of a social networking system may display a plurality of comments or postings from different users, and each stored comment has a user-specific sentiment value associated with it in comment store 42. For a particular comment, the user-specific sentiment value associated with the comment has been determined by the particular user who authored, created or posted the comment.

Although block 710 indicates that a user-specific sentiment value for a particular comment is stored, block 710 does not require displaying the sentiment value. Instead, the sentiment value may be stored without display and still used as a basis of filtering comments in subsequent steps.

At block 720, a specified user sentiment value range related to an entity is received. The selected user sentiment value range may be a sub-range of a sentiment value range. The range may be implicit or explicit. An implicit range may be determined when user input specifies a single scalar user sentiment value; for example, receiving a specified user sentiment value of “60” may imply a range of allowable sentiment values of comments of “60” to “100,” where “100” is the maximum possible sentiment value. In an embodiment, the sentiment value range may be an explicit numerical range with a minimum and a maximum value.

In an embodiment, at block 730, in response to receiving or determining the specified user sentiment value range at block 720, a social network system causes displaying only comments for the entity that are associated with user sentiment values that are within the range that was received or determined at block 720. Block 730 may comprise redisplaying a user interface display to include only comments for the entity that are within the range that was received or determined. Alternatively, the process of FIG. 7 may be implemented in the context of a database query system in which blocks 710, 730 do not involve displaying but instead involve receiving a database query and generating a filtered result set of comments for use in a separate display system or another different system.

In an embodiment, using the illustrated process, a social network system may filter and cause providing or displaying comments by receiving or determining a selected sentiment value range related to an entity and displaying only comments related to the entity that have associated user sentiment values within the selected range. In this manner, a particular user can define that user's specific sentiment value or a range so that only comments of other users having a similar or better sentiment for a particular entity are displayed. Alternatively, in some embodiments the approach may be implemented to cause displaying or returning only comments having sentiment that is less than the specified user-specific sentiment value.

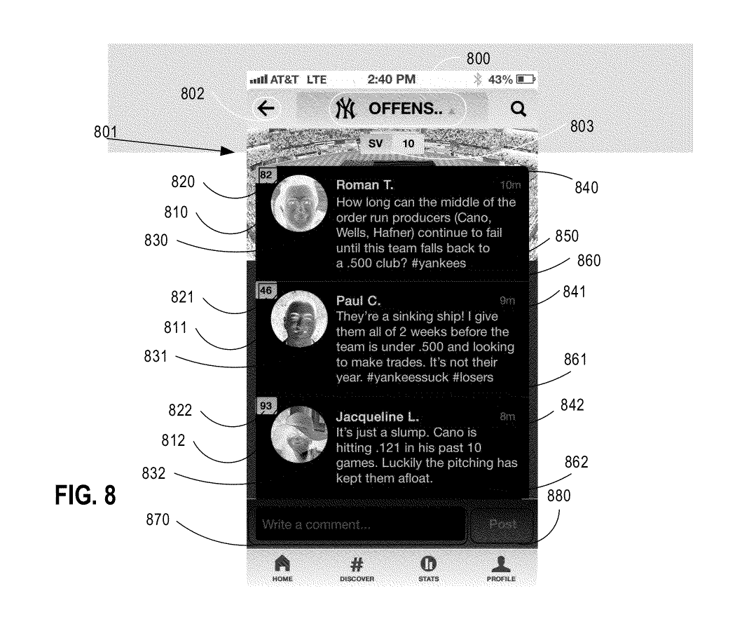

FIG. 8 illustrates an example of a graphical user interface to view filtered user comments related to a sports entity, in an embodiment. In an embodiment, a screen display 801 may be accessed from the screen display 203 of FIG. 3 by selecting link 320 in FIG. 3. Conversely, in an embodiment, selecting a return link 802 in FIG. 8 may cause redisplaying the screen display 203 of FIG. 3.

In an embodiment, screen display 801 may be generated in a mobile computing device coupled to a social network system that is configured to display a plurality of comment entries related to an entity. In the example of FIG. 8, the entity is the sports team NEW YORK YANKEES as seen at label 800 and a plurality of comment entries 810, 811, 812 are displayed. While screen display 801 of FIG. 8 shows three (3) comment entries for purposes of illustrating a clear example, in other embodiments there may be any number of comment entries in the screen display. In one embodiment, each comment entry 810, 811, 812 may comprise a comment by a user that may optionally include one or more hashtags, a user identifier, a user sentiment value related to the entity and a total contribution count made by the user to the social network system. For example, comment entry 810 comprises a user sentiment value 820, a user identifier 830, a comment 860, a hashtag 850, and a contribution count 840.

In an embodiment, the social network system displays the comment entries in an order based on total contribution entry counts. Thus, comment entry 810 is ordered first based upon a total contribution count 840 of 10 million, the comment entry 811 is ordered second based upon a total contribution count 841 of 9 million, and comment entry 812 is ordered third with a total contribution count 842 of 8 million.

In screen display 801, each comment entry 810, 811, 812 has an associated user sentiment value for the entity. For example, in comment entry 810, a comment 860 was contributed by user Roman T. as seen in user identifier 830, and that user is associated with a user sentiment value 820 of “82” for the sports team entity NEW YORK YANKEES. This is considered fairly high, so Roman T. may be seen as a fan of the Yankees. Similarly, comment entry 811 of user Paul C. as seen in user identifier 831 has an associated user sentiment value 821 of “46,” and comment 812 of user Jacqueline L. as identified at 832 has an associated user sentiment value 822 of “93.”

In an embodiment, user interface 801 further comprises a sentiment value filter indicator 803 that indicates a particular sentiment value that has been used to filter the display of the comment entries 810, 811, 812. In the example of FIG. 8, sentiment value filter indicator 803 is “10” and the app 14 and social networking application 32 (FIG. 1) are configured with logic to display only comment entries having individual user sentiment values that are greater than or equal to “10”. For example, comment entries 810, 811, 812 are shown in the screen display 801 because the user sentiment values of “82”, “46”, “93” for the users who made those comments, with respect to the NEW YORK YANKEES as indicated at 800, all are greater than “10”. In contrast, any comment entries of users who have a user sentiment value for the NEW YORK YANKEES of “9” or less are filtered out and excluded from the screen display 801.

In an embodiment, screen display 801 comprises an input text box 870 that is configured to accept a new comment of a user. A post button 880 may be displayed adjacent to the text box 870 and in response to selection of the post button, the app 14 transmits text entered in the text box to the social networking application 32 for storage; concurrently, screen display 801 is refreshed to display a comment entry for the entered comment, similar in format to comment entry 810, 811 and 812.

In an embodiment, the social networking application 32 may be configured to send the new comment to other social network systems. For this purpose or other purposes, one or more comments may contain tag values that are capable of processing in the other social network systems. For example, comment 860 contains a hashtag 850 that capable of processing by the TWITTER social network system.

User interface 801 also is configured to cause associating the new comment that is entered using text box 870 with the then-current user sentiment value for the current user with respect to the entity shown at 800. The user sentiment value is then displayed as part of the new comment entry in a location similar to that of user sentiment values 820, 821, 822.

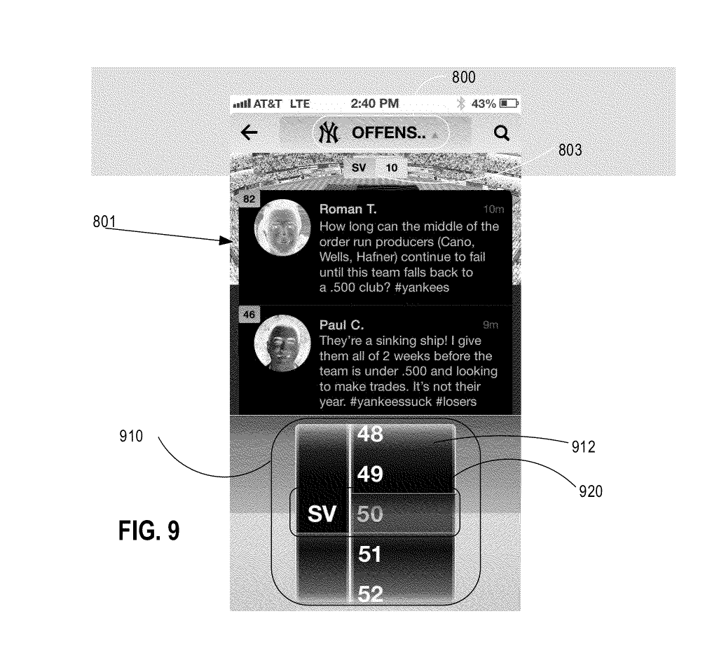

FIG. 9 illustrates an example of a graphical user interface for a selection of a sentiment value range to filter user comments related to a sports entity, in an embodiment. In an embodiment, selecting or tapping on the sentiment value filter indicator 803 causes displaying a value selection widget 910 comprising a selection dial 912 and a selection region 920. In an embodiment, the selection dial 912 comprises an animated, graphically rotatable user interface widget that responds to touch gestures, such as dragging or sliding, by appearing to rotate to display a range of available sentiment values. For example, in one embodiment in response to touch gesture input indicating downward sliding, the app 14 causes redisplaying the selection dial 912 using animated movement to graphically appear to rotate to display decreasing values in the selection region 920. Further, ceasing such touch gesture input causes the selection dial 912 to stop. Thereafter tapping the indicator 803 or another part of the screen display 801 may cause storing the sentiment value indicated in selection region 920 as the filter value that is shown by the sentiment value filter indicator 803, and redisplaying the screen display to re-filter comments based upon the newly selected value.

Thus, in one embodiment the app 14 displays a minimum sentiment value using indicator 803 of “10” based on a full sentiment value range of 1 to 100. To change the selected sentiment value range, the sentiment value filter indicator 803 may be selected. In response to the selection, the social network system displays widget 910 with dial 912. By rotating the dial, a new minimum sentiment value for comments may be selected. In an embodiment of FIG. 8, a new minimum sentiment value of “50” has been selected.

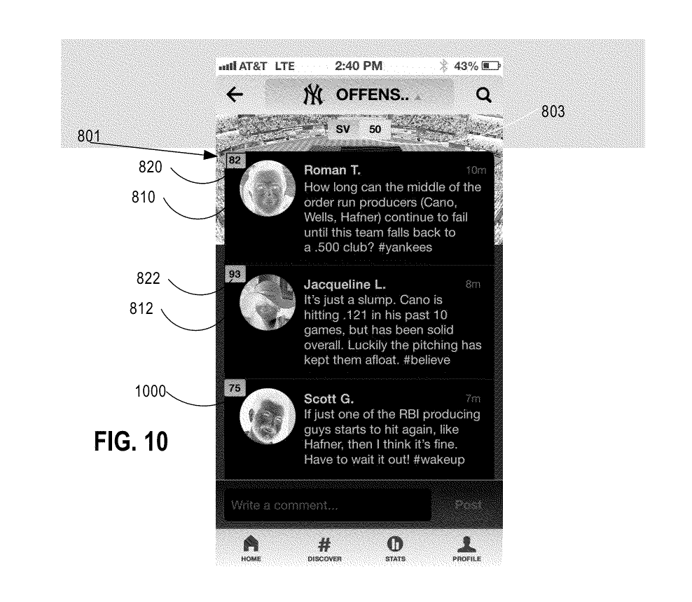

FIG. 10 illustrates an example of a graphical user interface for displaying comments in response to a selection of a new minimum sentiment value, in an embodiment. In FIG. 10, the value shown with the sentiment value filter indicator 803 has been updated to “50” in response to the operations described above for FIG. 9. Further, the comment entries 810, 811 have been re-filtered to display only those comments for users having a sentiment value of “50” or greater with respect to the NEW YORK YANKEES. As a result, comment entry 812 of FIG. 8 is no longer displayed, and a new comment entry 1000 is displayed; the new comment entry is displayed because the user sentiment value of user Scott G. is “75,” which is greater than “50”, and because the removal of comment entry 812 provides space in the screen display 801 to show other comments of users with a sentiment value of greater than “50”.

4. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

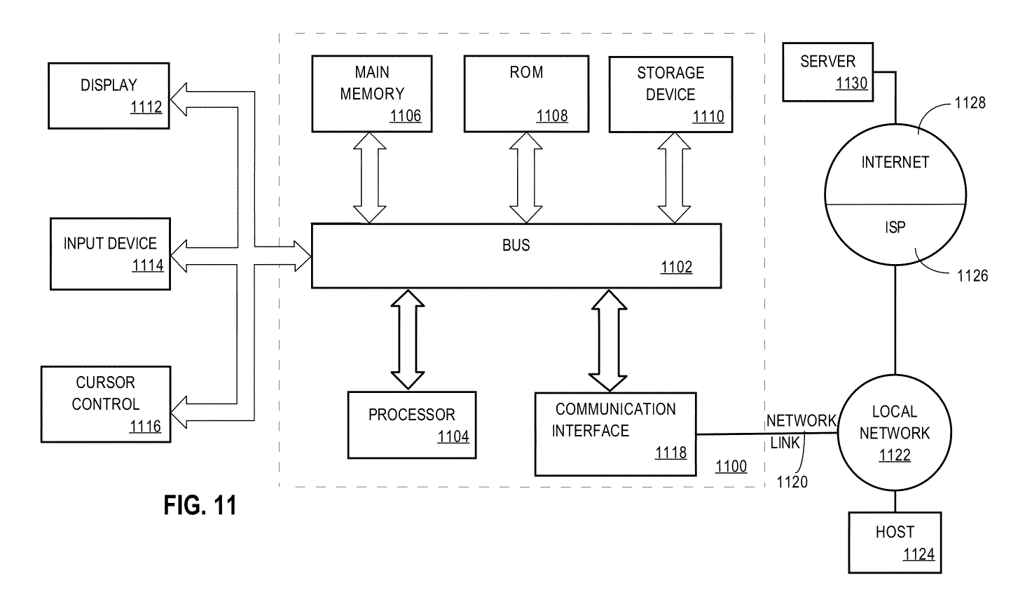

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or solid-state drive is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Other Disclosure

The disclosure also encompasses the subject matter of the following numbered clauses:

15. A method comprising: using a computing device, displaying a plurality of comments; using the computing device, receiving, a selected range of sentiment values related to a sports entity wherein the selected range of sentiment values is within a range of values that correspond to user sentiments relating to the sports entity in which a higher value indicates a more positive sentiment; in response to receiving the selected range of sentiment values, using the computing device, causing displaying one or more comments from the plurality of comments wherein each comment is related to the sports entity and each comment has an associated user sentiment value that is within the selected range.

16. The method of Clause 15 wherein each comment in the plurality of comments is related to the sports entity and has an associated user sentiment value.

17. The method of Clause 16 comprising displaying a name for the sports entity and the associated user sentiment values of the plurality of comments.

18. The method of Clause 15, comprising displaying a comment filter dial in association with the plurality of comments and comprising a graphical sentiment value indicator that specifies a maximum sentiment value in the selected range and is in the comment filter dial in a position that indicates the maximum sentiment value within the range.

19. The method of Clause 15, wherein the range of sentiment values is from 1 to 100.

20. The method of Clause 15, wherein displaying the plurality of comments further comprises, displaying the plurality of comments in an order, wherein the order is determined by a count that is based on a total number of received comments related to each comment in the plurality of comments.

21. The method of Clause 15, wherein displaying the one or more comments further comprises, displaying the one or more comments in an order, wherein the order is determined by a count that is based on a total number of received comments related to each comment in the plurality of comments.

22. The method of Clause 15, comprising publishing a comment in the plurality of comments to a social media site.

23. The method of Clause 22, wherein the comment contains a tag recognized by the social media site.

24. The method of Clause 15, comprising displaying a comment filter slider in association with the plurality of comments and comprising a first graphical sentiment value indicator that specifies a minimum sentiment value in the selected range and is in the comment filter slider in a position proportional to the minimum sentiment value within the range, and displaying a second graphical sentiment value indicator that specifies a maximum sentiment value in the selected range and is in the comment filter slider in a second, different position proportional to the maximum sentiment value within the range.

25. The method of Clause 15, comprising: causing displaying a comment entry form in a display of a mobile computing device that displays the plurality of comments; receiving comment data entered in the comment entry form and in response, adding to the plurality of comments a comment that is based on the comment data.

40. A computer system comprising: one or more processors; one or more non-transitory computer storage media coupled to the one or more processors and comprising one or more sequences of instructions which, when executed by the one or more processors, cause performing: using a computing device, displaying a plurality of comments; using the computing device, receiving, a selected range of sentiment values related to a sports entity wherein the selected range of sentiment values is within a range of values that correspond to user sentiments relating to the sports entity in which a higher value indicates a more positive sentiment; in response to receiving the selected range of sentiment values, using the computing device, causing displaying one or more comments from the plurality of comments wherein each comment is related to the sports entity and each comment has an associated user sentiment value that is within the selected range.

41. The computer system of Clause 40 wherein each comment in the plurality of comments is related to the sports entity and has an associated user sentiment value.

42. The computer system of Clause 41 comprising sequences of instructions which when executed cause displaying a name for the sports entity and the associated user sentiment values of the plurality of comments.

43. The computer system of Clause 40, comprising sequences of instructions which when executed cause displaying a comment filter dial in association with the plurality of comments and comprising a graphical sentiment value indicator that specifies a maximum sentiment value in the selected range and is in the comment filter dial in a position that indicates the maximum sentiment value within the range.

44. The computer system of Clause 40, wherein the range of sentiment values is from 1 to 100.

45. The computer system of Clause 40, wherein displaying the plurality of comments further comprises, displaying the plurality of comments in an order, wherein the order is determined by a count that is based on a total number of received comments related to each comment in the plurality of comments.

46. The computer system of Clause 40, wherein displaying the one or more comments further comprises, displaying the one or more comments in an order, wherein the order is determined by a count that is based on a total number of received comments related to each comment in the plurality of comments.

47. The computer system of Clause 40, comprising sequences of instructions which when executed cause publishing a comment in the plurality of comments to a social media site.

48. The computer system of Clause 47, wherein the comment contains a tag recognized by the social media site.

49. The computer system of Clause 40, comprising sequences of instructions which when executed cause displaying a comment filter slider in association with the plurality of comments and comprising a first graphical sentiment value indicator that specifies a minimum sentiment value in the selected range and is in the comment filter slider in a position proportional to the minimum sentiment value within the range, and displaying a second graphical sentiment value indicator that specifies a maximum sentiment value in the selected range and is in the comment filter slider in a second, different position proportional to the maximum sentiment value within the range.

50. The computer system of Clause 40, comprising sequences of instructions which when executed cause: displaying a comment entry form in a display of a mobile computing device that displays the plurality of comments; receiving comment data entered in the comment entry form and in response, adding to the plurality of comments a comment that is based on the comment data.

What is claimed is:

1. A method comprising:
using a computing device, displaying a first name and a first sentiment value of a first sports entity wherein the first sentiment value is within a range of values that correspond to user sentiments relating to the first sports entity in which a higher value indicates a more positive sentiment;
using the computing device, displaying a second name and second sentiment value of a second sports entity, wherein each of the second sports entity and the first sports entity is related to a team entity;
using the computing device, receiving a particular sentiment value that is for the first entity and is within the range of values;
in response to receiving the particular sentiment value, using the computing device, recalculating the first sentiment value and calculating a team sentiment value corresponding to the team entity;
causing redisplaying the first sentiment value in association with the first name.

2. The method of claim 1, comprising recalculating the first sentiment value based on aggregating a plurality of other sentiment values of the first sports entity that are received from a plurality of different user computing devices.

3. The method of claim 2, wherein the aggregating comprises determining an average, a minimum or a maximum.

4. The method of claim 1, comprising calculating the team sentiment value based on aggregating a plurality of other sentiment values for all sport entities that relate to the team entity and that are received from a plurality of different user computing devices.

5. The method of claim 4, wherein the aggregating comprises determining an average, a minimum or a maximum.

6. The method of claim 1, comprising causing displaying team information related to the team entity and comprising at least the team sentiment value.

7. The method of claim 1, comprising causing displaying a first sentiment change value for the first sports entity indicating a change in the first sentiment value during a time.

8. The method of claim 7, comprising displaying a second sentiment change value for the team entity indicating a change in the team sentiment value during a time.

9. The method of claim 8, comprising selecting the first sports entity and the second sports entity based upon the first sentiment change value and the second sentiment change value exceeding one or more trend threshold values that are associated with trends in changes in the first sentiment change value and the second sentiment change value.

10. The method of claim 1, comprising displaying a first sentiment value selection slider in association with the first name and comprising a first graphical sentiment value indicator that specifies the first sentiment value and is in the first sentiment value selection slider in a position proportional to the first sentiment value within the range, and displaying a second sentiment value selection slider in association with the second name and comprising a second graphical sentiment value indicator that specifies the second sentiment value and is in the second sentiment value selection slider in a second, different position proportional to the second sentiment value within the range.

11. The method of claim 1, comprising causing displaying a comment selection link in association with the first name; receiving selection data indicating a selection of the comment selection link; causing displaying a plurality of comments relating to the first sports entity that have been received from other computing devices and that are associated with other sentiment values that are greater than or equal to the first sentiment value.

12. The method of claim 1, comprising:
causing displaying a poll selection link in a display of a mobile computing device that displays the first name;
receiving first selection data indicating a selection of the poll selection link, and in response, displaying a statement related to a third sports entity or second team entity;
using the computing device, causing displaying a set of voting links related to the statement;
using the computing device, receiving second selection data indicating vote selection of one of the voting links, and in response, calculating a number of votes received from other computing devices for all voting links for the statement, and causing displaying the number of votes in association with an aggregate sentiment value of the third sports entity or second team entity.

13. The method of claim 12 comprising displaying the statement at a position in a sequence of statements that is determined based on a trend in the number of votes received for the statement.

14. The method of claim 12 comprising displaying the voting links using first and second different distinctive appearances when a voting selection related to the statement has been received and has not been received.

15. A computer system comprising:
one or more processors;
one or more non-transitory computer storage media coupled to the one or more processors and comprising one or more sequences of instructions which, when executed by the one or more processors, cause performing:
using a computing device, displaying a first name and a first sentiment value of a first sports entity wherein the first sentiment value is within a range of values that correspond to user sentiments relating to the first sports entity in which a higher value indicates a more positive sentiment;
using the computing device, displaying a second name and second sentiment value of a second sports entity, wherein each of the second sports entity and the first sports entity is related to a team entity;
using the computing device, receiving a particular sentiment value that is for the first entity and is within the range of values;
in response to receiving the particular sentiment value, using the computing device, recalculating the first sentiment value and calculating a team sentiment value corresponding to the team entity;
redisplaying the first sentiment value in association with the first name.

16. The computer system of claim 15, comprising sequences of instructions which when executed cause recalculating the first sentiment value based on aggregating a plurality of other sentiment values of the first sports entity that are received from a plurality of different user computing devices.

17. The computer system of claim 16, wherein the aggregating comprises determining an average, a minimum or a maximum.

18. The computer system of claim 15, comprising sequences of instructions which when executed cause calculating the team sentiment value based on aggregating a plurality of other sentiment values for all sport entities that relate to the team entity and that are received from a plurality of different user computing devices.

19. The computer system of claim 18, wherein the aggregating comprises determining an average, a minimum or a maximum.

20. The computer system of claim 15, comprising sequences of instructions which when executed cause displaying team information related to the team entity and comprising at least the team sentiment value.

21. The computer system of claim 15, comprising sequences of instructions which when executed cause displaying a first sentiment change value for the first sports entity indicating a change in the first sentiment value during a time.

22. The computer system of claim 21, comprising sequences of instructions which when executed cause displaying a second sentiment change value for the team entity indicating a change in the team sentiment value during a time.

23. The computer system of claim 22, comprising sequences of instructions which when executed cause selecting the first sports entity and the second sports entity based upon the first sentiment change value and the second sentiment change value exceeding one or more trend threshold values that are associated with trends in changes in the first sentiment change value and the second sentiment change value.

24. The computer system of claim 15, comprising sequences of instructions which when executed cause displaying a first sentiment value selection slider in association with the first name and comprising a first graphical sentiment value indicator that specifies the first sentiment value and is in the first sentiment value selection slider in a position proportional to the first sentiment value within the range, and displaying a second sentiment value selection slider in association with the second name and comprising a second graphical sentiment value indicator that specifies the second sentiment value and is in the second sentiment value selection slider in a second, different position proportional to the second sentiment value within the range.

25. The computer system of claim 15, comprising sequences of instructions which when executed cause displaying a comment selection link in association with the first name; receiving selection data indicating a selection of the comment selection link; causing displaying a plurality of comments relating to the first sports entity that have been received from other computing devices and that are associated with other sentiment values that are greater than or equal to the first sentiment value.

26. The computer system of claim 15, comprising sequences of instructions which when executed cause:
displaying a poll selection link in a display of a mobile computing device that displays the first name;
receiving first selection data indicating a selection of the poll selection link, and in response, displaying a statement related to a third sports entity or second team entity;
using the computing device, causing displaying a set of voting links related to the statement;
using the computing device, receiving second selection data indicating vote selection of one of the voting links, and in response, calculating a number of votes received from other computing devices for all voting links for the statement, and causing displaying the number of votes in association with an aggregate sentiment value of the third sports entity or second team entity.

27. The computer system of claim 26 comprising sequences of instructions which when executed cause displaying the statement at a position in a sequence of statements that is determined based on a trend in the number of votes received for the statement.

28. The computer system of claim 26 comprising sequences of instructions which when executed cause displaying the voting links using first and second different distinctive appearances when a voting selection related to the statement has been received and has not been received.
